(19) United States
(12) Patent Application Publication
(10) Pub. No.: US 2022/0146972 A1
(43) Pub. Date: May 12, 2022

(54) COLOR CALIBRATION

(71) Applicant: Hewlett-Packard Development Company, L.P., Spring, TX (US)

(72) Inventors: Yoav Landau, Ness Ziona (IL); Ran Waidman, Ness Ziona (IL); Nir Guttman, Ness Ziona (IL)

(73) Assignee: Hewlett-Packard Development Company, L.P., Spring, TX (US)

(21) Appl. No.: 17/434,025

(22) PCT Filed: Jul. 17, 2019
(86) PCT No.: PCT/US19/42270

§ 371 Date: Aug. 26, 2021

(51) Int. Cl. G03G 15/00; G06K 15/02; G06K 15/14

(52) U.S. Cl. CPC G03G 15/5062; G06K 15/14; G06K 15/027

(57) ABSTRACT

An example of printing calibration includes printing a calibration page having test patches, the test patches developed at a plurality of voltages of a binary ink developer. The test patches are measured to determine an indication of ink thickness of the patches and a calibration voltage is generated based on the indications of the ink thickness of the test patches.

### BACKGROUND

Images and text may be formed on a substrate using a photoconductive element. Print substances may be transferred to and from the photoconductive element using charged surfaces and/or rollers and/or by forming electric fields between surfaces and/or rollers. Such methods may be referred to as electrophotography.

### BRIEF DESCRIPTION OF THE DRAWINGS

Various examples will be described below by referring to the following figures.

FIG. 1 is a schematic diagram of an example electrophotographic device.

FIG. 2 is example diagram of a calibration pattern used by an example electrophotographic device.

FIG. 3 is an example plots of voltage levels and calibration results used by an example electrophotographic device.

FIG. 4 is a system diagram illustrating components of an example electrophotographic device.

FIG. 5 is a flow diagram illustrating example processes for performing calibration of an electrophotographic device.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

A number of methods exist for forming an mage on a substrate, such as a web or a sheet of paper. The act of forming an image or text on a substrate is referred to herein as printing or forming an impression. By way of example, one method of impression comprises electrophotography (EP), which refers to a method of forming an image on a substrate using a photoconductor and selectively charged surfaces and/or voltage potentials.

Depending on a particular implementation, an EP device capable of using a print fluid may comprise a number of transfer surfaces (e.g., drums or rollers) between a reservoir and a substrate. As used hereinafter, surfaces, rollers, and drums are referred to interchangeably as drums or rollers, without limitation, and are not intended to be taken in a limiting sense. In one such implementation, the process of impression includes transferring a print fluid having charged solids (e.g., negatively charged solids) from one transfer surface to the next until finally depositing the print fluid (e.g., softened solids of the print fluid) on the substrate. For instance, one such example process may comprise developing print fluid in a developer unit and selectively transferring the developed print fluid to a photoconductive drum onto which a latent image has been fixed, such as by exposure to light (e.g., a negatively charged photoconductor may be selectively discharged by a laser or LED). The transfer of print fluid to the photoconductive drum may be referred to as a zero transfer. The photoconductive drum may transfer the print fluid representing the latent image to an intermediate transfer member (ITM), which may include a transfer blanket. The transfer of print fluid to the ITM may be referred to as a first transfer. At the ITM, the liquid portion of the print fluid may evaporate and remaining resin-based solids may soften. The ITM may transfer the solids to a surface of a substrate, which transfer may be referred to as a second transfer. A supporting impression drum may support the substrate and facilitate adhering the solids to the substrate, such as through the application of heat and/or pressure in combination with the ITM and the transfer blanket.

As part of an impression process, transferring print fluid from one surface to another may comprise setting different voltage potentials at different components of an EP device such that a differential voltage forms a field between components to cause print fluid (e.g., solids) to transfer from one surface to another (e.g., attracting negatively charged print fluid solids to a second surface having a voltage potential that is less negative than a voltage potential of the first surface).

One such transfer is performed between a binary ink developer (BID and a photo imaging plate (PIP). The transfer uses selectively applied voltages to a number of BIDs in order to transfer different colored pigments to the PIP. For example, there may be bids for each of three colors and black which generate images in many colors together. The BIDs of each color receive a voltage in turn that causes print material in that BID to transfer to the PIP. The PIP rotates to receive each color one at a time to develop an image that will be transferred to a substrate

A contributing factor the output color of an EP device is determined by the voltage differential between a BID and a PIP. If the voltage is too high, more than a target amount of print fluid may be deposited resulting in too high of an ink thickness. If the voltage is too low, less than a target amount of print fluid may be deposited resulting in too low of an ink thickness. Based on print material, the voltages of each BID may be different to generate accurate images.

Over time based on changes to print substances, the environment, or the components of the EP itself, the voltage may be calibrated periodically over time. While referred to herein as ink thickness, generally the thickness of any print material deposited onto a substrate could be measured to calibrate an EP system using the systems and processes described herein. For example, solid pigment print material may be included in the term ink thickness.

Systems may calibrate the voltage by printing a page at a test voltage, measuring one or more aspects, such as ink thickness, of the calibration page and adjust the voltage up or down accordingly. The process is iterated by printing additional pages at changing voltages until an output ink thickness within specified parameters is achieved. The EP device may then set the calibration voltage and proceed with normal operations.

While the process provides a calibration voltage to meet specification, it utilized a number of pages worth of a substrate and a print material from each of the BIDs. This results in wasted materials as well as increased downtime for the EP device as additional calibration pages are printed by the system.

Disclosed herein is an EP system to provide voltage calibration using a single calibration page. The system changes voltage as the page is printed and generates a number of test patches. The test patches may be arranged into horizontal rows with each of the rows having specified voltage differential between the BID and the PIP. The test patches are measured by the EP system to select a voltage matching specified parameters. For example, the test patches may be measured for reflectance to determine an ink thickness generated by the process. The measured correlations between voltage and ink thickness can then be interpolated to determine a best fit for the voltage calibration.

To generate the test patches, the EP system prints rows of patches at different voltages. Each row may contain patches for three colors and black. These may be transferred from the BID to the PIP at different voltages depending on the print material used. Accordingly, the test patches may be developed and calibrated at different voltages for each of the BIDs. In some examples, the voltages may be selected to cover an expected range of voltages that the print materials are printed at, or capable of being generated by the EP system. The resulting measurement data is then fit in a regression to determine a selected calibration voltage. In some examples, the EP system may use a smaller range based around a previous calibration voltage in order to potentially provide increase accuracy. For example, an electric field generator may generate voltages between 300V and 700V. The EP system may sample voltages in a range within 100V of the previous calibration voltage.

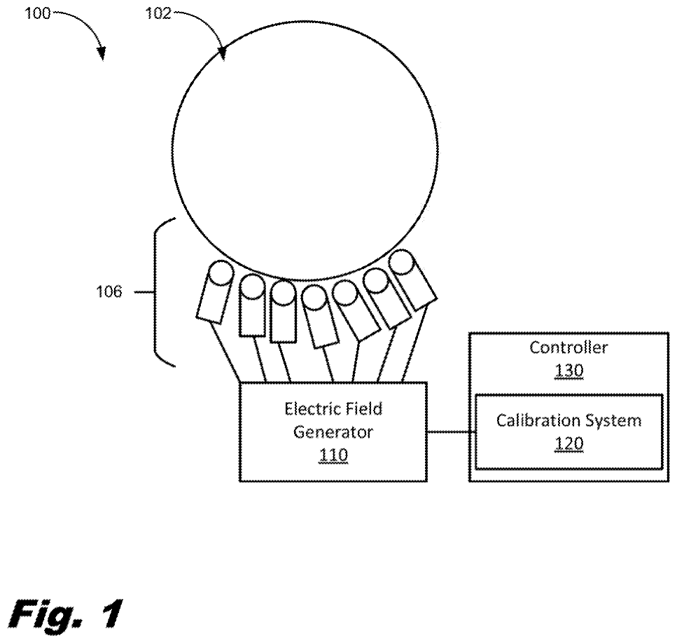

FIG. 1 is a schematic illustration of several example components of an EP device 100. As shown, the EP device 100 includes a number of BIDs 106 coupled to an electric field generator 110. The voltage applied by the electric field generator 110 to the BIDs 106 corresponds to an amount of print material transferred to the PIP 102. For example, a higher voltage differential between the BIDs 106 and the PIP 201 results in a larger amount of print material being transferred to the PIP 102. The print material transferred to the PIP 102 is transferred to other drums or webs in order to develop print material onto a substrate.

The electric field generator 110 may be generally operated by a controller 130. For example, the electric field generator 110 may apply a determined electric field to BIDs in order to develop an image on an output substrate. In some examples, the electric field generator 110 applies an electric field directly to the developer of the BID 106. The electric field generator 110 may also operate by applying the electric field to the developer of the BID 106 while also taking into account electric fields applied to various components of the EP device 100. The timing and location at of pixels developed on the PIP causes the selective transfer of print material from the BID to the PIP so as electric field generator 110 applies an electric field to the BIDS pixels generate that develop into a final image.

The controller 130 also operates a calibration system 120 to calibrate the voltage generated by the electric field generator 110. Accordingly, a calibration voltage is set which set the amount of print material transferred from the BID to the PIP. The calibration may be updated periodically to improve print quality, such as color accuracy, developed on substrates. For example, calibration may be performed at predetermined intervals of time, in response to quality specifications changing, in response to a number of pages printed, in response to a change in output quality, based on a user's command, or at other times. In some examples, the recommended calibration may be performed at intervals of approximately 6000 prints, or 1500 each of three colors and black.

The controller 130 is also coupled to an ink thickness sensor 140. In some examples, the ink thickness sensor 140 may be an optical sensor that emits a test signal into patches of the calibration page and receives a reflected optical signal. Based on the intensity of the reflected signal, the calibration system 120 can identify a correlated ink thickness. The ink thickness sensor 140 may provide a measurement of ink thickness to the controller 130 to use when determining a calibration voltage for the EP device 100. In some examples, the ink thickness sensor 140 may also he an image forming apparatus, such as a camera or video camera. Such a device may capture an image of the test patches and perform image processing to analyze the accuracy of the colors generated. Herein, the output substrate having test patches printed thereon is referred to also as a calibration page.

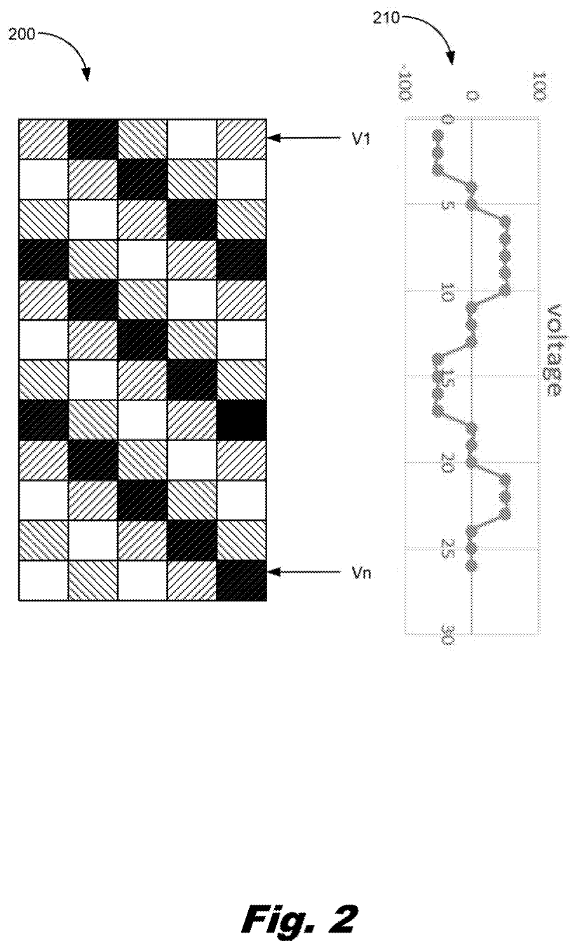

FIG. 2 shows an example calibration page 200 as used by an EP system described herein to provide calibration in one page. Voltage chart 210 shows corresponding voltages that are applied to generate the calibration page 200. The calibration page shows patches printed for three colors and a black in a pattern on the page. In the example calibration page 200, the test patches are arranged horizontally into rows. The corresponding voltage chart 210 shows that the horizontally arrange rows are printed at different voltages to provide a range of test voltages to measure and use for calibration. The voltage chart 210 shows one set of voltages horizontal row. In some examples, however, each BID may have a different voltage chart 201 with voltages based on historical calibration values or physics related to the print material.

While shown in a particular format, the calibration page 200 may have different characteristics in various examples. For instance, the calibration page 200 is shown with 5 patches printed in each row of the calibration page. Furthermore, the number of rows may be selected based on accuracy desired, a range of voltages that are being tested characteristics of the printing system, or the like. In addition, calibration page 200 is shown with each color represented in each row. In various examples, each color may not be represented in each row. One of the print materials may not have been used and therefore may not be calibrated in the current calibration cycle or certain print materials may not be calibrated at the frequency.

In some examples, rather than having consistent patch sizes, the calibration page 200 may also include test patches corresponding to the length of the circumference of the drum of the PIP. Accordingly, there may be a longer patch than test patches at changing voltages. This enables the EP system to measure any changes or inconsistencies present in the PIP. For example, a scratch on the PIP may change the amount of build material transferred. Based on any defects or inconsistencies, later measurements in the test patches can be compensated to include information about changes unrelated to the voltage differential between the BID and the PIP.

Similarly, as shown, the voltages in the voltage chart 210 are repeated in several rows. This further protects any defects that may be present in a single point of data. Those defects may be based on the physics of the PIP, the tolerances of the electric field generator, the tolerances of the ink thickness sensor, or other variances within the system.

As shown in voltage chart 210, the voltage is varied around a starting test voltage. In some examples, the starting test voltage is selected as a previous calibration voltage. The starting test voltage may also be selected as a predetermined test voltage based on intended operating voltages. For example, based on manufacturer settings, based on historic data, as a midpoint of operating ranges, or the like. Additionally, the voltage may be increased linearly rather than varied around the test voltage.

The calibration page 200 is measured by an ink thickness sensor. In some examples, the ink thickness sensor may be a reflectance sensor that emits a test signal into the test patch and receives a signal in return. For example, an optical signal may return having an intensity that indicates the ink thickness on the calibration page.

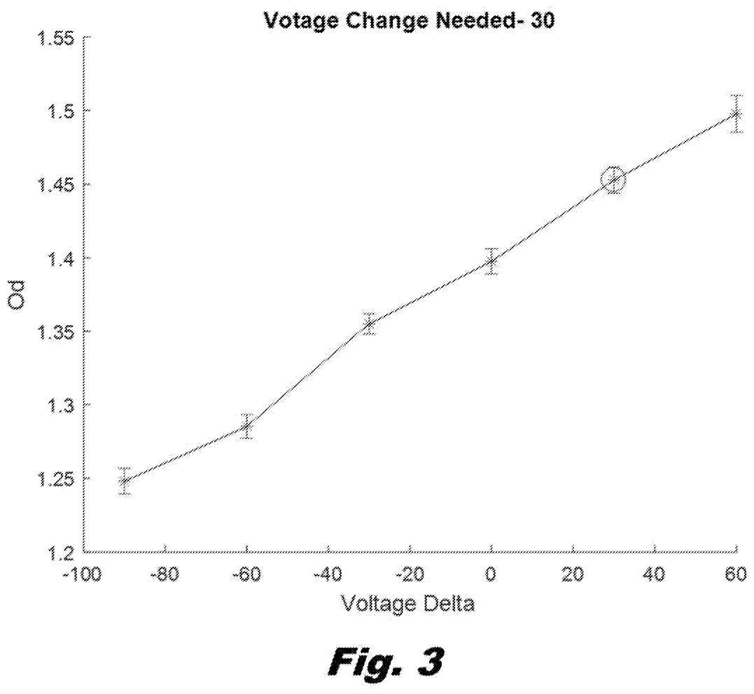

FIG. 3 shows example data generated by an EP system performing voltage calibration. The x-axis of the data indicates the test voltages applied. In this example, the data is organized to show a change in calibration, but represents an absolute voltage differential to apply. The y-axis is an indication of the reflectance received by an ink thickness sensor. The y axis data is compared to specification of the EP system to determine what voltage to set as a calibration voltage. The data includes a regression 310 that can be used to interpolate data between measured points. Accordingly, with fewer measured data points additional accuracy can be added to the selection of the calibration voltage.

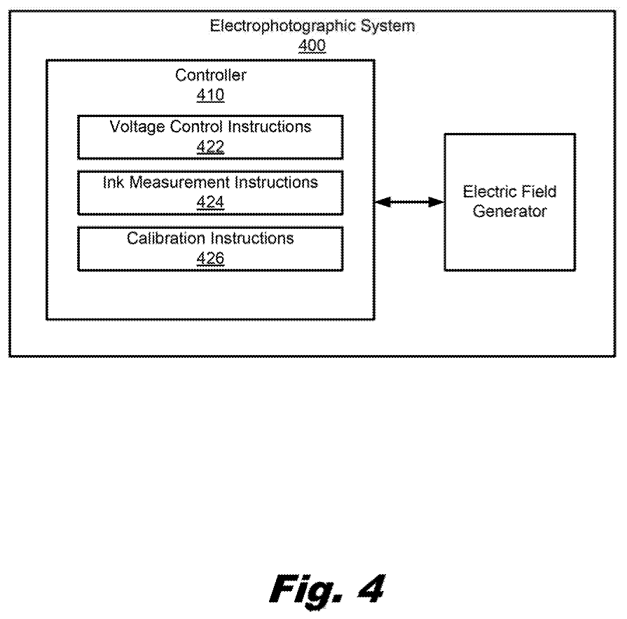

Referring now to FIG. 4 an example EP system 400 is shown having additional details of a controller 410. For example, the controller 410 may be the same or similar to that described above with reference to controller 130 of FIG. 1. The controller may include a processor and a memory to execute instruction that perform the calibration processes described herein. The processor may be a microprocessor, microcontroller, CPU or other processing device capable of executing instructions. The processor may be electronically coupled to a memory that stores the instructions for executing. For example, a processor and memory may cause the performance of the operations described with reference to FIG. 1.

In some examples, the controller 410 includes voltage controller instructions 422, ink measurement instructions 424, and calibration instructions 426. The voltage control instructions 422, when executed, control the voltage output by an electric field generator 430 during normal operations, this includes applying the calibration voltage to each BID during a printing process to generate pixels on the PIP. The resulting amount of print material transferred based on the calibration voltage applied to each BID in turn are applied to a substrate and combine to form a specified color thereon.

During calibration processes, the voltage control instructions 422 cause an electric field generator 430 to vary the voltage applied to the BIDs to generate test patches. For instance, during the voltage control instructions 422 may instruct the electric field generator 430 to generate a set of voltage differences as shown with respect to chart 210 above. After the calibration process, the voltage control instructions 422 return to instructing the BID based on a color map.

Ink measurement instructions 424 measure an ink thickness of the calibration pages. For instance, as discussed further above, the ink measurement instructions may control an ink measurement sensor. In some examples, wherein the ink measurement sensor is an optical sensor, the ink measurement instructions 424 may control emitting of an optical signal and interpreting the results of the reflected signal. In examples using an image capture device, the ink measurement instructions 424 may perform image processing to determine the accuracy of colors on the calibration page.

Calibration instructions 426 use the output of the ink measurement instructions 424 to determine a calibration voltage of the EP system 400. The calibration instructions 426 causes the controller to use the measurements of ink thickness correlated with the test voltages to determine the calibration voltage. For example, the calibration instructions 426 may use the test voltage that produces the closes measurements to specified measurement as the new calibration voltage. In some examples, the calibration instructions 426 cause the controller to interpolate the data and determine a closer fit to the specifications. For example, the controller may perform a regression on the data and determine a voltage that fits the regression as the calibration voltage. In some examples, the determined calibration voltage may be different for each color BID. Accordingly, the process may be repeated.

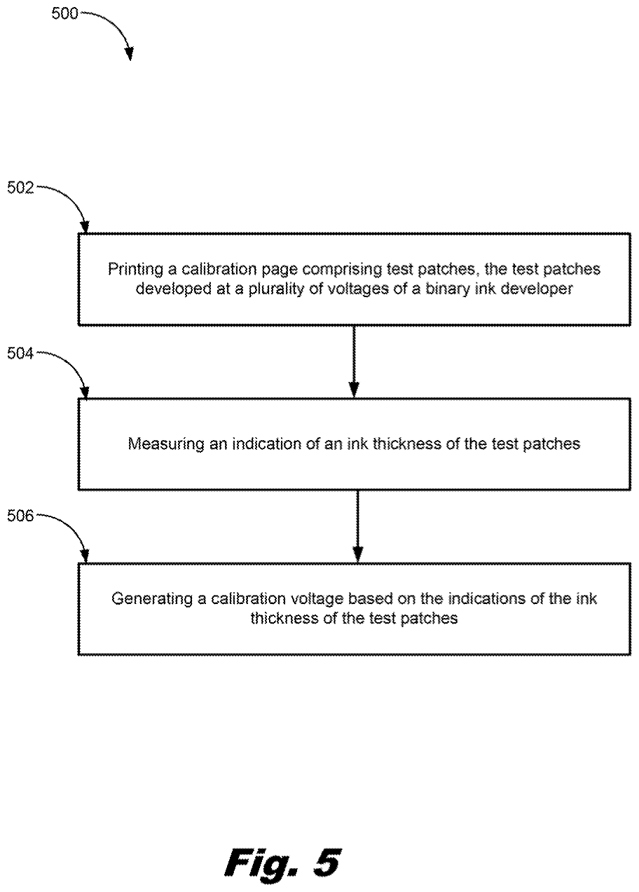

FIG. 5 illustrates an example flow diagram 500 that may be performed by an EP system. For example, the EP system may similar to those described above with reference to FIGS. 1-4. The flow diagram may be performed based on instructions from a controller as described with reference to FIG. 4, for instance In various examples, the flow diagram 500 may have fewer or additional processes than shown in FIG. 5. In addition, blocks in flow diagram 500 can be performed in a different order or may be performed at the same time.

In block 502 an EP system prints a calibration page comprising test patches. The test patches are developed at a plurality of voltages of a binary ink developer. For examples, as described above, a number of BIDs may print a number of test patches on a calibration page. The test patches may be in each of three colors and black. The test patches include multiple voltages for each of the pigments. In some examples, the test patches include patches that are of a length to match the diameter of a PIP. This enables measurement across the diameter of the PIP. Any variances in measured ink thickness may be attributed to the PIP and used to calibrate measurement of additional test patches. In some examples, multiple test patches are generated for each pigment at each voltage to ensure accurate measurement.

In block 504, the EP system measures indication of an ink thickness of the test patches. For example, an optical sensor may emit an optical signal into the test patch. A reflectance of a return signal indicating reflectance can be used to generate a measurement of ink thickness. For example, a higher reflectance may indicate less ink thickness, while a lower reflectance may indicate greater ink thickness. In some examples, other sensors may be used to measure ink thickness. For example, image capture devices or the like. In addition, sensors in a variety of spectrum, including infrared, visible, microwave, x-ray, or others may be used to probe the calibration page to determine an ink thickness.

In block 506, the EP system generates a calibration voltage based on the indication of the ink thickness of the test patches. In some examples, generating the calibration voltage includes selecting a tested voltage that generates an ink thickness closest to a specified ink thickness. The EP system may also select a test voltage by interpolating the data points to determine a voltage between data points predicted to have closer results to a specified thickness. In some examples, the determined calibration voltage may be different for each color BID. Accordingly, the processes in flow diagram 500 may be repeated 4 times.

It will be appreciated that examples described herein can be realized in the form of hardware, software or a combination of hardware and software. For example, the controllers 130 and 410 described in FIGS. 1 and 4 may be implemented in a combination of hardware or software. Any such software may be stored in the form of volatile or non-volatile storage. For example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any claim and a machine-readable storage storing such a program.

The features disclosed in this specification (including any accompanying claims, abstract and drawings), and/or the operations or processes of any method or process so disclosed, may be combined in any combination, except combinations where at least some of such features and/or processes are mutually exclusive.

Each feature disclosed in this specification (including any accompanying claims, abstract, and drawings), may be replaced by alternative features serving the same, equivalent or similar purpose, unless expressly stated otherwise. Thus, unless expressly stated otherwise, each feature disclosed is example of a generic series of equivalent or similar features.

What is claimed is:

1. A method comprising:
printing a calibration page comprising test patches the test patches developed at a plurality of voltages of a binary ink developer;
measuring an indication of an ink thickness of the test patches; and
generating a calibration voltage based on the indications of the ink thickness of the test patches.

2. The method of claim 1, further comprising:
selecting a first voltage of the binary ink developer based on a previous calibration voltage of a previous calibration; and
selecting the plurality of voltages of the binary ink developer in a range of voltages surrounding the first voltage.

3. The method of claim 1, wherein printing the calibration page comprising test patches further comprises printing a plurality of test patches each using a plurality of print materials.

4. The method of claim 1, wherein generating the calibration voltage comp interpolating a fit of the voltage to the indication of ink thickness and determining the calibration voltage based on a comparison to a target ink thickness.

5. The method of claim 1, wherein measuring a first indication of a t ink thickness of a first test patch comprises:
emitting a test signal onto the first test patch; and
receiving an optical signal indicating a reflectance of the first test patch.

6. The method of claim 1, wherein printing the test patches comprises printing a first test patch of a length of a circumference of a drum of a photo imaging plate.

7. A printing system comprising:
a photo image plate to apply ink to a transfer blanket;
a plurality of binary ink developers to apply ink to the photo image plate;
an electric field generator to generate an electric field between the binary ink developer and the photo image plate; and
a controller to:
set the electric field at a first voltage to print a first test patch to a calibration page;
set the electric field to a second voltage to print a second test patch to the calibration page;
receive a first indication of a first ink thickness of the first test patch and a second indication of a second ink thickness of the second test patch; and
determine, based on the first indication and the second indication, a calibration voltage for the electric field generator.

8. The printing system of claim 7, further comprising an optical sensor to:
provide a test signal to the first patch;
receive a reflected optical signal from the first patch; and
generate the first indication of the first ink thickness based at least in part on an intensity of the reflected optical signal.

9. The printing system of claim 7, wherein the, controller is further to:
select the first voltage of the electric field based on a previous calibration voltage of a previous calibration; and
selecting the second voltage of the electric field to generate an indication of a relationship between the electric field and ink thickness.

10. The printing system of claim 7, wherein the controller is further to:
print a first set of test patches at the first test voltage arranged horizontally on the calibration page to the first test patch; and
print a second set of test patches at the second voltage arranged horizontally on the calibration page to the second test patch; and
print a third set of test patches at a third second voltage arranged horizontally on the calibration page to a third test patch.

11. The printing system of claim 10, wherein the controller is further to interpolate the calibration voltage based on measurements of the first set of test patches, the second set of test patches, and the third set of test patches.

12. The printing system of claim 7, wherein the controller is further to print a plurality of test patches at the first voltage and a plurality of test patches at the second voltage to determine a plurality of calibration voltages for a plurality of print materials.

13. A printing system comprising:
an electric field generator to generate an electric field between a binary ink developer and a photo image plate, and
a controller to:
vary a voltage of the electric field to print a plurality of test patches on a single calibration page;
receive an indication of ink thickness for the plurality of test patches; and
interpolat a calibration voltage for the electric field based on the received indications.

14. The printing system of claim 13, wherein to vary the voltage of the electric field, the controller is further to vary the voltage around a previous calibration voltage of the electric field.

15. The printing system of claim 14, wherein the previous calibration voltage of the electric field is between 300V and 700V.
